(19) United States
(12) Patent Application Publication
(10) Pub. No.: US 2014/0262057 A1
(43) Pub. Date: Sep. 18, 2014

(54) METHOD OF CONTROLLING A WINDOW TREATMENT USING A LIGHT SENSOR

(71) Applicant: Lutron Electronics Co., Inc., Coopersburg, PA (US)

(72) Inventors: Samuel F. CHAMBERS, Gwynedd Valley, PA (US); Stephen LUNDY, Coopersburg, PA (US); Brent PROTZMAN, Easton, PA (US)

(73) Assignee: Lutron Electronics Co., Inc., Coopersburg, PA (US)

(21) Appl. No.: 13/841,010

(22) Filed: Mar. 15, 2013

(51) Int. Cl. E05F 15/20; E06B 9/68

(52) U.S. Cl. CPC E05F 15/20; E06B 9/68
USPC 160/5; 160/405

(57) ABSTRACT

A method of controlling a motorized window treatment adjacent to a window or skylight comprises: measuring a light intensity at the window having the window treatment adjacent to the window or skylight; computing a first position of the window treatment based on the measured light intensity, that is expected to produce a predetermined interior illuminance at a predetermined position in a room containing the window or skylight; and automatically actuating the window treatment to the first position.

### FIELD

This disclosure relates to control systems for controlling one or more motorized window treatments in a space while minimizing occupant distractions.

### BACKGROUND

Motorized window treatments, such as, for example, motorized roller shades and draperies, provide for control of the amount of sunlight entering a space. Some motorized window treatments have been automatically controlled in response to various inputs, such as indoor light sensors and timeclocks. Such systems typically seek to maximize the amount of available natural sunlight entering the space. However, the automatic control algorithms of prior motorized window treatments may result in causing many distractions to occupants of the space.

### SUMMARY

In some embodiments, a system comprises a window treatment positioned adjacent to a window or skylight of a room, a motor associated with the window treatment, for varying a position of the window treatment, a sensor for measuring an outdoor light level at the window or skylight, and a controller for generating and transmitting signals to the motor to automatically adjust the position of the window treatment so as to control task illumination at a predetermined location in the room based on the measured outdoor light level at the window or skylight.

In some embodiments, a method of controlling a motorized window treatment adjacent to a window or skylight comprises: (a) measuring a light intensity at the window having the window treatment adjacent thereto; (b) computing a first position of the window treatment based on the measured light intensity, that is expected to produce a predetermined interior illuminance at a predetermined position in a room containing the window or skylight; and (c) automatically actuating the window treatment to the first position.

In some embodiments, a method of controlling a motorized window treatment adjacent to a window, (where the window is located on a wall of a room) comprises: (a) measuring a light intensity at the window having the window treatment adjacent thereto, (b) computing a predicted maximum light intensity at the window during an interval following the measuring, the computing based on the measured light intensity, (c) computing a first position of the window treatment based on the predicted maximum light intensity, such that exposing the window and window treatment to light having the predicted maximum light intensity would produce a predetermined interior illuminance; (d) computing a second position of the window treatment for use during the interval, corresponding to a predetermined maximum sunlight penetration distance of the room; and (e) automatically actuating the window treatment to whichever one of the first and second positions that permits less light past the window treatment.

In some embodiments, a non-transitory machine readable storage medium is encoded with computer program code, such that when the code is executed by a processor, the processor performs a method of controlling a motorized window treatment adjacent to a window or skylight, comprising: (a) receiving a value of light intensity measured at the window or skylight having the window treatment adjacent thereto; (b) computing a first position of the window treatment based on the measured light intensity, that is expected to produce a predetermined interior illuminance at a predetermined position in a room containing the window or skylight; and (c) automatically causing the window treatment to move to the first position.

### BRIEF DESCRIPTION OF THE DRAWINGS

FIG. 1A is a block diagram of an embodiment of a system as described herein.

FIG. 1B is a block diagram of another configuration of the system of FIG. 1A.

FIG. 2 is a diagram of a room in which the system of FIG. 1A is used.

FIG. 3A is a flow chart of a control method using the system of FIG. 1A.

FIG. 3B is a flow chart of an optional application of the method.

FIGS. 4A-4D are diagrams showing a window treatment aligned with architectural features.

FIG. 5A is a flow chart of a method of configuring the system of FIG. 1A to control task illumination while constraining the window treatment to a predetermined set of discrete positions.

FIG. 5B is a flow chart of a method of configuring the system of FIG. 1A to control task illumination while constraining the window treatment to positions which correspond to a predetermined set of discrete illumination levels.

FIG. 6 is a flow chart of a method of operating the window treatment to control task illumination while constraining the window treatment to a predetermined set of discrete positions.

FIG. 7 is a flow chart of a procedure for controlling task illumination predictively for a planning period.

FIG. 8 shows a procedure for running alternative window treatment control algorithms and selecting the position which best prevents excess illumination or glare at the task surface.

FIGS. 9A to 9D are diagrams showing the relevant parameters for control based on depth of penetration of sunlight.

### DETAILED DESCRIPTION

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

FIG. 1A is a block diagram of a load control system 100 operable to control the position of one or more motorized window treatments 104, e.g., motorized roller shades, to control the amount of sunlight entering the space. The load control system 100 is adapted for controlling a motorized window treatment 104 to enhance user comfort and productivity. The load control system 100 provides open loop control of task illumination in a space 160 (FIG. 2), based a measurement by the exterior sensor, by controlling the positions of the various window treatments in the space 160, and the daylight entering the space. The motorized window treatment 104 is positioned adjacent to a window 166 (FIG. 2) or skylight of a room. The basic example in FIG. 1A includes a single roller shade, but in various other embodiments, the motorized window treatment 104 can comprise motorized draperies, blinds, roman shades, or skylight shades; and any desired number of motorized window treatments 104 can be included. In each of the examples herein, the figures show roller shades, but motorized draperies, blinds, roman shades, or skylight shades or the like can be substituted.

Each of the motorized roller shades 104 comprises an electronic drive unit (EDU) 130, which may be located, for example, inside a roller tube 172 of the associated roller shade. Each electronic drive unit 130 includes an AC or DC motor, and is coupled to a controller 136 for receiving signals from the respective controller. The motor of the electronic drive unit 130 is associated with one or more motorized window treatments 104, for varying a position of the window treatment(s) e.g., a shade fabric 170. The controller 136 can include a microcontroller, embedded processor, or an application specific integrated circuit. An example of a motorized window treatment control system is described in greater detail in commonly-assigned U.S. Pat. No. 6,983,783, issued Jun. 11, 2006, entitled MOTORIZED SHADE CONTROL SYSTEM, the entire disclosure of which is hereby incorporated by reference. The controller 136 has at least one wired or wireless communication link to at least one sensor 180.

In some embodiments, the control logic 136, instructions 105 and data 103 for controlling the operation of the motorized window treatment 104 are all locally contained in or on the housing of the motorized roller shade 104. For example, system 100 contains data 103, computer program instructions 105, and its own system clock 107 as well as a communications interface. In various embodiments, the communications interface may contain any one or more of an RF transceiver 109 and antenna 111, a WiFi (IEEE 802.11) interface, a Bluetooth interface, or the like. In other embodiments, the controller has a wired communications interface, such as X10 or Ethernet. A self-contained system 100 as shown can operate independently, without receiving instructions from an external processor. In some embodiments, the controller 136 is configured to operate independently, but is also responsive to manual overrides or commands received from an external processor.

In some embodiments, the controller 136 is further coupled to one or more additional motorized window treatments 104, and/or a central control processor 150. For example, in some embodiments, the controller 136 is connected to a transceiver 109 and antenna 111 for transmitting and receiving radio-frequency (RF) signals to/from the central control processor 150, which can be configured with its own transceiver 152 and antenna 154. The controller 136 is responsive to the received signals for controlling the electronic drive units 130 for controlling the motorized roller shades. Examples of a radio frequency motorized window treatments are described in greater detail in commonly assigned U.S. Pat. No. 7,723,939, issued May 25, 2010, entitled RADIO-FREQUENCY CONTROLLED MOTORIZED ROLLER SHADE, and U.S. Patent Application Publication No. 2012/0261078, published Oct. 18, 2012, entitled MOTORIZED WINDOW TREATMENT, the entire disclosures of which are hereby incorporated by reference.

In other embodiments, the controller 136 receives program commands from the central control processor 150, and reports sensor data and window treatment position to the central control processor. The application logic for determining how to operate the system resides in the central processor 150. In some embodiments, the central control processor 150 is located in the same room as the motorized window treatment 104. In other embodiments, the central control processor 150 is located in a different room from the motorized window treatment 104. Thus, the system can include a variety of configurations of distributed processors.

The window treatment control system 100 further comprises a light sensor 180 for measuring an outdoor light level at the window or skylight. The example of the light sensor 180 shown in FIG. 1 measures vertical illuminance. In some embodiments a second light sensor (which may be a rooftop sensor 182) provides a horizontal illuminance measurement. The light sensor 180 may be mounted to the inside surface of a window 166 (FIG. 2) in the space 160 or to the exterior of the building. The light sensor 180 may mounted on or in the housing 181 of the motorized window treatment 104 (between the window and the window treatment). In other embodiments (not shown), the sensor may be battery-powered and may be operable to transmit wireless signals, e.g., radio-frequency (RF) signals, to the controller 136 via the antenna 111 and transceiver 109. For example, the sensor 180 can be a window mounted sensor, configured to be attached to a frame element or muntin of the window, on the external side of the window. In some embodiments, the sensor 180 can be configured to attached to a mullion of the window.

In response to signals received from the light sensor 180, the controller 136 is operable to control actuation of the window treatment in one of a plurality of operating modes, and to cause the system to transition from one operating mode to another, as described in greater detail below. The load control system 100 may comprise a plurality of light sensors located at different windows around the building (as well as a plurality of sensor receiver modules), such that the load control system 100 may enable the sunlight penetration limiting mode in some areas of the building and not in others. Examples of multi-sensor load control systems are described in U.S. Patent Application No. US 2012/0091804, which is incorporated by reference herein.

FIG. 1B shows another configuration of the system, including a plurality of motorized window treatments 104 and electronic drive units 130, and a lighting control subsystem. The load control system 100 is operable to provide open loop control of the level of task illumination in the space 160 by controlling the positions of the various window treatments in the space 160, and the daylight entering the space. Fine adjustment of the task illumination level can be provided by an interior sensor 113 (FIG. 2). As shown in FIG. 1B, the light control subsystem is operable to control the amount of power delivered to (and thus the intensity of) a plurality of lighting loads, e.g., a plurality of fluorescent lamps 102.

Each of the fluorescent lamps 102 is coupled to one of a plurality of digital electronic dimming ballasts 110 for control of the intensities of the lamps. The ballasts 110 are operable to communicate with each other via digital ballast communication links 112. For example, the digital ballast communication link 112 may comprise a digital addressable lighting interface (DALI) communication link. Each digital ballast communication link 112 is also coupled to a digital ballast controller (DBC) 114, which provides the necessary direct-current (DC) voltage to power the communication link 112 and assists in the programming of the load control system 100. The ballasts 110 are operable to transmit digital messages to the other ballasts 110 via the digital ballast communication link 112.

The electronic drive units 130 are responsive to digital messages received from a wallstation 134 via a shade communication link 132. In some embodiments, the user can use the wallstation 134 to open or close the motorized roller shades 104, adjust the position of a shade fabric 170 (FIG. 2) of the roller shades, or set the roller shades to preset shade positions between an open-limit position (e.g., a fully-open position P_{FO}) and a closed-limit position (e.g., a fully-closed position PO. The user can also configure the operation of the motorized roller shades 104 using the wallstations 134. A shade controller (SC) 136 is coupled to the shade communication link 132.

A plurality of lighting hubs 140 act as central controllers for managing the operation of the ballasts 110 and the electronic drive units 130 of the load control system 100. Each lighting hub 140 is operable to be coupled to at least one of the digital ballast controllers 114 to allow the lighting hub to communicate with the ballasts 110 on one of the digital ballast communication links 112. Each lighting hub 140 is further operable to be coupled to the shade controller 136 to allow the lighting hub to communicate with the electronic drive units 130 of the motorized roller shades 104 on one of the shade communication links 132. The lighting hubs 140 are further coupled to a processor 150 (e.g., a desktop or laptop computer, tablet, smart phone, or other mobile device, or an embedded processor) via a communications link (e.g., Ethernet link 152 and standard Ethernet switch 154), such that the processor 150 is operable to transmit digital messages to the ballasts 110 and the electronic drive units 130 via the lighting hubs 140. The processor 150 executes a graphical user interface (GUI) software, which is displayed on a processor screen 156. The GUI software allows the user to configure and monitor the operation of the load control system 100. For example, each floor of a building may be assigned one or more lighting hubs 140. Each lighting hub 140 is in turn assigned one or more controllers 136, each of which controls operation of one or more window treatments 104.

FIG. 2 shows a space (e.g., a room) 160 in which the load control system 100 is used. The room has a window 166 at which themotorized window treatment 104 is mounted. In the example, the motorized roller shade 104 is mounted above the window 166 and comprises a roller tube 172 around which the shade fabric 170 is wrapped. The shade fabric 170 may have a hembar 174 (FIG. 1) at the lower edge of the shade fabric. The electronic drive unit 130 rotates the roller tube 172 to move the shade fabric 170 between the fully-open position PFO (in which the window 166 is not covered) and the fully-closed position PFC (in which the window 166 is fully covered). Further, the electronic drive unit 130 may control the position of the shade fabric 170 to one of a plurality of preset positions between the fully-open position PFO and the fully-closed position PFC.

The top of the window has a height h_{win} (FIG. 9A). A task surface is defined, having a working height h_{WORK} and a distance d_{TASK} from the window 166. The system computes a window treatment position, such that an open loop estimate of the interior task illumination based on the current exterior light level, as measured by the photo sensor 180—without taking into account any interior illumination measurement—is approximately the desired target task illumination level. In various embodiments, the computation can be an arithmetic calculation or a table lookup (with or without interpolation between table entry values). In some embodiments, the computation is performed by making a selection from a table of coefficient of utilization (CUreq) values (without interpolation), where CUreq is defined by:

CUreq=(desired task surface light level)/(light level measured at the window).

This selection results in rounding to the shade position corresponding to the nearest lower CU value in the appropriate CU table to ensure a lower light level at the task surface than the user's desired task surface illumination level. The target task illumination level depends on the nature of the work being performed. For example, users who spend most of their working day looking at a computer display may prefer a lower light level than workers who are processing paper. By way of non-limiting examples, an atrium may have a target illumination of 200 foot-candles. An employee working at a computer, may only desire 30 foot candles.

By controlling the window treatment position based on the expected task illumination level computed from the actual measured exterior light intensity—without taking into account any interior illumination measurement—the system 100 avoids repeated opening and closing of shades, which can occur in bright light conditions when measurements from an interior sensor are used to control the shades (or to control both the lights and shades). Under bright light conditions, such systems would close the shades completely (to the PFC position). Upon expiration of any minimum delay between shade motions, such a system would open the shades, detect the bright light level, and close the shades again. In the example of FIG. 2, the sensor 180 is either on the exterior side of the window 166, or between the window and the motorized window treatment 104, so that the sensor 180 can detect the exterior light level, even when the window treatment is in the fully closed position. This avoids having the system mistake a fully closed shade for a low exterior light condition and open the shade while the light is still very bright.

FIG. 3A is a flow chart of an embodiment of a method for window treatment control.

At step 300, the sensor 180 measures the outdoor (exterior) light level, and provides the data to the controller 136.

At step 302, the controller 136 determines the desired window treatment position corresponding to the exterior light level, as measured by the sensor 180. Thus, interior task surface illumination is controlled by adjusting the shade position in response to the measured exterior illumination level. The shade position control is an open loop control, and does not rely on feedback based on the actual task surface illumination. This determination may be made using a variety of techniques, non-limiting examples of which are provided below.

At step 304, the controller 136 determines whether the position determined in step 302 would admit less light (i.e., is more closed) than the current position. If the determined position is more closed than the current position, step 308 is performed. If the determined position is the same or more open than the current position, step 306 is performed. Step 304 allows the system to implement different strategies for responding to increased and decreased exterior light levels.

When the determined position of the window treatment is the same or more opened than the current position (because the measured light level has decreased), the controller 136 determines whether a predetermined minimum time interval has passed since a most recent movement of the window treatment at step 306. If the predetermined minimum time interval has passed step 312 is performed. If the predetermined minimum time interval has not yet passed, step 310 is performed.

At step 308, when the determined position of the window treatment is more closed than the current position (because the measured light level has increased) the system can optionally provide hysteresis by calculating whether a change in position ΔPOSITION (i.e., the difference between the current position and the determined position) is greater than a minimum change threshold ΔMIN (e.g., 5 mm). If the calculated change in position ΔPOSITION is greater than ΔMIN, step 312 is performed. If not, step 310 is performed. The minimum change threshold ΔMIN can be set to a small value, so that the window treatment is not moved, if the calculated change is less than the accuracy of the sensor, for example. In some embodiments, the minimum change threshold ΔMIN is set to zero, so that the controller 136 always changes the position of the window treatment immediately in response to any increase in exterior light intensity that is expected to result in a task surface illumination level in excess of the desired task-appropriate illumination level, regardless of how small. In other embodiments, step 308 is omitted, and the controller 136 always changes the position of the window treatment immediately in response to any increase in exterior light intensity, regardless of how small.

At step 310, the controller 136 delays a movement of the window treatment for increasing an unshaded area of the window or skylight, if the predetermined minimum time interval has not passed, or if the calculated change in position is less than ΔMIN. This is the case where the illumination level is low enough to provide a comfortable, task appropriate illumination level to the user. Given the choice between immediately raising the shade (and distracting or annoying the user with frequent movements) or delaying the movement (and passing up available natural light or view), this embodiment is biased towards delaying the movement, and avoiding distraction due to frequent movements.

At step 312, the controller 136 generates and transmits signals to the motor of the EDU 130 to automatically adjust the position of the window treatment so as to control the expected task illumination at a predetermined location in the room based on the measured outdoor light level at the window or skylight. Thus, the controller 136 causes the window treatment to move immediately if the expected task illumination level based on the exterior light intensity has increased, or if the window treatment has not been moved for at least the predetermined minimum time and the expected task illumination level has decreased. In some embodiments, the controller 136 uses PID control to control either the velocity or position of the window treatment during the window treatment actuating step.

In an alternative embodiment, steps 304-310 are omitted. The controller 136 immediately raises or lowers the shade to respond to any change in lighting. This makes the system more responsive to illumination changes of all types, but does result in an increased number of movements during times of changing exterior light conditions. The responsiveness of the system may also be changed by setting the value of the minimum time delay between window treatment movements to zero.

In some embodiments, a second sensor 113 (FIG. 2) is provided for measuring the actual task surface illumination. The measurements taken by the second sensor 113 are used to control the indoor lamps 102 to adjust the light level to the target task illumination level. In various embodiments, the second sensor 113 may be mounted on the ceiling, a wall, or on the task surface itself. If the second sensor 113 is located proximate to a light source 102 such as a lamp, the sensor is oriented, so as not to directly detect the light from the light source 102.

FIG. 3B shows an additional feature used in some embodiments.

At step 350, outdoor illumination is measured using a first sensor 180 which is not responsive to illuminance within the room. The sensor can be located outside of the window 166, or between the window glass and the motorized window treatment 104.

At step 352, the motorized window treatment is automatically controlled based on the measurement from the first sensor, and a selected task illumination level corresponding to the expected use of the room.

At step 354, the illuminance within the room is measured using a second sensor 113.

At step 356, the light(s) in the room are automatically controlled based on the measurement from the second sensor, to achieve the desired task illumination.

By controlling the lights using the measurements from the second sensor, ping-ponging between opening and closing the window treatment is avoided.

FIGS. 4A-4D show an example of a system in which the controller 136 is programmed to operate the motorized window treatment 104 in a discrete set of predetermined positions. The predetermined positions correspond with architectural features of the room in which the motorized window treatment 104 is installed. In FIGS. 4A-4D, the architectural features are muntins 167 (which may be actual muntins separating small panes, or simulated muntins added to the window for decorative appearance) or other horizontal bars or beams. In FIG. 4A, the system is in a first position, in which the hem bar 174 of the shade fabric 170 is aligned with the top muntin 167 (not shown). When the shade fabric 170 is in the first position, approximately 25% of the window 166 is shaded (i.e., covered by the window treatment) and approximately 75% of the window is unshaded (i.e., not covered by the window treatment). In FIG. 4B, the system is in a second position, in which the hem bar 174 of the shade fabric 170 is aligned with the second muntin 167. In FIG. 4C, the system is in a third position, in which the hem bar 174 of the shade fabric 170 is aligned with the third muntin 167. In FIG. 4D, the system is in a fourth position, in which the hem bar 174 is at the bottom of the window in the fully closed position PFC, i.e., 100% of the window 166 is shaded.

In the example of FIGS. 4A-4D the window 166 has one or more architectural features 167, and at least one of the preset positions is selected to cause a bottom 174 of the motorized window treatment 104 to align with one of the architectural features 167. Nevertheless, the architectural features are not limited to members within the window 166. In other embodiments the architectural features can include other architectural elements of the room (e.g., chair rail, work surface height, or the like).

FIG. 5A is a flow chart for a method of configuring the controller 136 to provide the discrete positions shown in FIGS. 4A-4D. A table configured in this manner can be used to compute the desired position in an embodiment employing a table lookup without interpolation. When the table is used, the determination of the desired shade position includes rounding to the shade position corresponding to the nearest lower coefficient of utilization (CUreq) in the table that is lower than or equal to the CUreq to ensure a task surface light level that does not exceed the desired task surface light level.

The controller has a non-transitory machine readable storage medium configured to store data 103 (FIG. 1A) corresponding to shade positions, and corresponding CUreq values (according to the appropriate CU table for the current lighting conditions). In some embodiments, the CUreq versus shade position data 103 are stored in a single table. In other embodiments, the medium includes two tables with shade positions and correspondingCUreq values: a first table to be used when the window is exposed to direct sunlight (near dawn and dusk) and a second table to be used when the window receives indirect (diffuse) sunlight, e.g., from an hour after dawn to an hour before dusk. In other embodiments, a plurality of diffuse light tables and a plurality of direct light tables are provided, each corresponding to a respectively different ratio of horizontal illumination level to vertical illumination level. The light level may constantly change on the vertical illuminance sensor 180. Thus, the controller can compare the computed CU value (CUreq=desired task surface light level divided by light level measured at the window.) to the values stored in the table(s) of Creq versus shade position.

At step 500, architectural features are selected.

At step 502, window treatment positions are selected, such that in those positions, the hem bar 174 or bottom of the window is aligned with the architectural features.

At step 504, the shaded and unshaded areas of the window are calculated for each of the identified positions.

At step 506, for each identified position of the window treatment, a table entry is computed, based on separate contributions to illumination from the shaded and unshaded areas of the window or skylight. If the sensor is on the exterior side of the window or skylight glass,

Entry=(AS*TG*TF*CU)+(AUS*TG*CU), where:

AS=shaded area;

TG=the transmittance of the window (or skylight) glass;

TF=transmittance of the window treatment fabric;

CU=the relevant coefficient of utilization; and

AUS=unshaded area;

If the sensor is on the interior side of the window or skylight glass, between the window and the window treatment,

Entry=AS*TF*CU+AUS*CU,

where the symbols AS, TF, CU and AUS have the same meanings set forth above.

In some embodiments, a first table is stored in the storage medium of the controller 136, with an entry for each position, where the coefficient of utilization is based on direct sunlight; and a second table is stored in the medium with an entry for each position, where the coefficient of utilization is based on diffuse light.

In some embodiments, the coefficient of utilization can be determined based on the standard tables provided in IESNA Lighting Handbook Ninth Edition, illuminating Engineering Society of North America, New York, N.Y., 2000, pp 8-13 to 8-17. The tables include coefficients for various ratios of room depth/window height, various depths (of the task surface to be illuminated) relative to the distance from the window to the opposite wall, and various ratios of window width to window height, based on standard floor, wall, and ceiling reflectance values. For each room and work area, the relevant parameters are input at the time of system installation, and the central control processor 150 identifies the relevant coefficients of utilization for diffuse light and direct sun.

In some embodiments, multiple coefficient of utilization (CU) tables are stored for different ratios of vertical to horizontal daylight illuminance. Such embodiments include an additional rooftop horizontal illuminance meter.

In some embodiments, a simplified calibration is done to make adjustments to the IES version of the CU table. For example, a relatively small number of measurements (including exterior illumination and corresponding task surface illumination in different locations) are taken in a representative space. The ratio of the measured CU to the IESNA predicted CU for the corresponding conditions is then used to define a scaling function that can be applied to other CU values in the IESNA table (or other established CU table). Application of the scaling function provides a custom table that can be used for spaces having similar floor, ceiling and wall coverings.

In other embodiments, a custom coefficient of utilization table can be populated by calibrating a standard room having the same wall, ceiling and floor coverings as the rooms in which the system is to be installed. The calculated interior daylight illuminance is given by:

Ei=Exv*T*CU,

where Ei is the interior illuminance on a reference point;

Exv is the exterior vertical illuminance on the window wall; and

T is the net transmittance of the window wall, including shaded and unshaded portions of the glass. The computed effective transmittance of the window is based on the predetermined illuminance and the measured light intensity, and corresponds to a first portion of the window covered by the window treatment and a second portion of the window not covered by the window treatment.

Interior illuminance values are collected at various ratios of room depth/window height, various depths (of the task surface to be illuminated) relative to the distance from the window to the opposite wall, and various ratios of window width to window height. This custom table can then be applied for rooms having similar wall, ceiling and floor coverings.

Since each of the predetermined window treatment positions has a known shaded area and unshaded area, the net transmittance T is readily calculated from material properties. The exterior vertical illuminance Exv is measured with the exterior photo sensor 180, and the interior illuminance Ei is measured with a second sensor 113, the values of the coefficient of utilization CU can be calculated during the calibration by:

CU=Ei/[Exv*T]

At step 508, he tables (for diffuse and direct sunlight) in the storage medium of the controller 136 are encoded with the plurality of preset positions for the window treatment, and a plurality of data representing predetermined CU values, each respective one of the preset window treatment positions corresponding to a respective predetermined CU value. The data representing predetermined CU values relate to the interior geometry and surfaces, and exterior light conditions. Some embodiments include a look up table, with a column of CU values and a column of corresponding shade positions. In some embodiments, the computations are done a priori and loaded into the table. In other embodiments, the shade positions are calculated in real time during use.

FIG. 5B shows an alternative method of populating the tables in the storage medium 103 of controller 136. In this embodiment, a set of predetermined external light intensity values are selected, and the corresponding window treatment positions are determined. Thus, the table of discrete values is focused on optimizing the positions at specific light intensity values, rather than the architecture of the room.

At step 510, a set of threshold exterior light levels are selected (e.g., 100, 200, 300, . . . , 2400 foot candles).

At step 512, the effective transmittance for each light level can be determined by:

T=(CU*Exv)/Ei.

The corresponding position of the window treatment can then be calculated from

T=(% open)*TG+(1−% open)*(TG+TF), where

% open is the position, determined by the percentage of the range of travel of the window treatment (from its most closed position), and is given by:

‘% open’=(AUS)/(AUS+AS)

If an outdoor sensor is used, the effective transmittance value TG takes into account the absorption and reflection of light by the window. If the sensor 180 is between the window and the window treatment, the measurement already takes into account absorption and reflection of light by the window, so a value of 1.0 can be inserted for TG.

At step 514, the position is computed for each light level and combination of light level, transmittance (window and fabric), and coefficient of utilization.

Thus, during installation and configuration of a motorized window treatment 104, the installer or system administrator inputs a plurality of parameters, including an expected use of the room. The controller 136 or central processor 150 stores predetermined task illumination levels corresponding to a predetermined set of uses for the space. Upon inputting the expected use, the system automatically selecting the predetermined interior illuminance based on the expected use. (In alternative embodiments, the user or administrator inputs the desired target illumination level directly). The installer or administrator also inputs TG (the transmittance of the window or skylight glass, TF (transmittance of the window treatment fabric), room depth, window height, depth of task surface relative to the window, window width and window height, based on standard floor, wall, and ceiling reflectance values.

FIG. 6 is a flow chart show operation of a controller 136 which has been configured with CU/window treatment position according to either of the methods in FIG. 5A or FIG. 5B. The storage medium of the controller 136 is thus configured with at least two tables: one table for diffuse light, and another table for direct sunlight.

At step 600, the controller 136 selects the current sun position (either a position that provides diffuse light or a position that provides direct sunlight) to ensure use of the appropriate coefficient of utilization. For purpose of determining which table to use, the light can be considered diffuse if it is a cloudy day, or if the time of day indicates that the solar elevation angle is too high for any direct sunlight to penetrate the window. In some systems, the determination of whether it is a cloudy day is made by comparing the current measured exterior light intensity to a constant cloudy day threshold value (e.g., 1000 foot-candles). In other systems, near sunrise and sunset, the cloudy day threshold value is reduced according to solar elevation angle, or time. In other embodiments online meteorological data are used for either the cloudy condition determination or the horizontal to vertical illuminance measurement. If available, such meteorological data may be substituted for calculated data based on sensor measurements

At step 602, the controller 136 compares the Creq (calculated using the measured light level) to the set of predetermined CU values in the appropriate table for diffuse light or direct sunlight.

At step 604, the controller 136 selects the nearest predetermined CU value (in the table) less than or equal to Creq. By “rounding” to the nearest lower CU value (without interpolation), the system is biased towards positions which admit less light, to ensure the user's comfort and protect the user from glare.

At step 606, the window treatment position is retrieved from the table value corresponding to the selected CU. The controller generates and transmits to the motor of EDU 130 signals to automatically adjust the position of the window treatment to the one of the preset positions corresponding to the closest lower CU value in the correct CU table (e.g., the table for diffuse or direct light, as appropriate) to ensure a lower light level.

FIG. 7 is a flow chart of an application of the method adding a predictive element. As discussed above, to avoid an excessive number of shade movements that could distract occupants, some embodiments include a minimum delay before implementing a window treatment movement to open the window treatment further (e.g., raise the shade). If the minimum delay between movements is relatively long (e.g., between one and two hours), the lighting conditions may change during the delay period. In some embodiments, the changes in light level after a shade movement are anticipated, and the shade movement is adjusted to ensure the occupant's comfort during the “planning period” during which the shade will not be opened further.

At step 700, the expected percentage change in light level at the end of the planning period is estimated, based on recent history. This can be achieved in a variety of ways.

In one embodiment, the light intensity values during the same time period in each recent day (e.g., 5, 7 or 10 days) are retrieved from the storage medium of the controller 136 and an average percentage increase or decrease for that time period is computed.

At step 702, the controller 136 determines whether the expected change is an increase or decrease. If an increase is expected, step 704 is performed. If a decrease is expected, step 706 is performed.

At step 704, the percentage increase computed in step 700 is multiplied by the current light intensity to obtain an expected light intensity at the end of the planning period. The controller 136 treats this end-of-planning period light intensity value as the maximum during the period, and selects the position of the window treatment corresponding to the end of the period. The window treatment is moved to that selected position, instead of the position corresponding to the current light intensity value.

At step 706, the controller 136 treats the current light intensity value as the maximum during the period, and selects the position of the window treatment corresponding to the current light intensity value (i.e., at the beginning of the planning period).

The embodiment of FIG. 7 estimates the maximum light intensity during the next planning period based on history data for the same time period in recent days. In an alternative embodiment, the maximum intensity during the planning period can be estimated by extrapolating from data collected during the past one to three hours. This can be achieved by fitting a regression polynomial to the data, or by linear extrapolation.

As described above, the system 100 is configured to ensure user comfort by estimating the interior task surface illumination level based on the light intensity at the window. In some situations (e.g., near sunrise or sunset) the absolute light level and task surface illumination may be low, but the occupant may still be exposed to direct sunlight and/or glare.

FIG. 8 is a flow chart in which an alternative window treatment position is calculated using a different criterion, and the controller 136 selects one of the two positions.

At step 800, the controller 136 determines a first window treatment position based on an estimated task surface illumination computed from the exterior light intensity.

At step 802, the controller 136 determines a second window treatment position based on limiting depth of penetration of sunlight.

At step 804, the controller 136 optionally determines a third window treatment position for limiting predicted glare.

At step 806, the controller 136 causes the window treatment to move to whichever one of the positions based on task illumination, limiting depth of penetration of sunlight and limiting predicted glare admits the least sunlight.

In some embodiments, step 804 is omitted, and the controller 136 computes a second position of the window treatment, corresponding to a predetermined maximum sunlight penetration distance of the room, and automatically actuates the window treatment to the second position, if in the second position the window treatment permits less light to pass than when the window treatment is in the first position.

FIGS. 9A-9D show geometric relationships used by a second method for calculating a shade position to avoid direct sun penetration at the task surface. FIG. 9A is a simplified side view of an example of the space 160 illustrating the sunlight penetration distance d_{PEN}, which is controlled by the motorized roller shades 104. The building comprises a façade (e.g., one side of a four-sided rectangular building) having a window 166 for allowing sunlight to enter the space. The space 160 also comprises a work surface, e.g., a table 168, which has a height h_{WORK}. The cloudy-day sensor 180 may be mounted to the inside surface of the window 166. The sunlight penetration distance d_{PEN} is the distance from the window 166 and the façade 164 at which direct sunlight shines into the room. The sunlight penetration distance d_{PEN} is a function of a height h_{WIN} of the window 166 and an angle φ_{F} of the façade 164 with respect to true north, as well as a solar elevation angle θ_{S} and a solar azimuth angle φ_{S}, which define the position of the sun in the sky. The solar elevation angle θ_{S} and the solar azimuth angle φ_{S} are functions of the present date and time, as well as the position (i.e., the longitude and latitude) of the building 162 in which the space 160 is located. The solar elevation angle θ_{S} is essentially the angle between a line directed towards the sun and a line directed towards the horizon at the position of the building 162. The solar elevation angle θ_{S} can also be thought of as the angle of incidence of the sun's rays on a horizontal surface. The solar azimuth angle φ_{S} is the angle formed by the line from the observer to true north and the line from the observer to the sun projected on the ground. When the solar elevation angle θ_{S} is small (i.e., around sunrise and sunset), small changes in the position of the sun result in relatively large changes in the magnitude of the sunlight penetration distance d_{PEN}.

The sunlight penetration distance d_{PEN} of direct sunlight onto the table 168 of the space 160 (which is measured normal to the surface of the window 166) can be determined by considering a triangle formed by the length l of the deepest penetrating ray of light (which is parallel to the path of the ray), the difference between the height h_{WIN} of the window 166 and the height h_{WORK} of the table 168, and distance between the table and the wall of the façade (i.e., the sunlight penetration distance d_{PEN}), i.e.,

tan(θ_{S})=(h_{WIN}−h_{WORK})/l, (Equation 1)

where θ_{S} is the solar elevation angle of the sun at a given date and time for a given location (i.e., longitude and latitude) of the building.

If the sun is directly incident upon the window 166, a solar azimuth angle φ_{S} and the façade angle φ_{F} (i.e., with respect to true north) are equal as shown by the top view of the window 166. Accordingly, the sunlight penetration distance d_{PEN} equals the length Q of the deepest penetrating ray of light. However, if the façade angle φ_{F} is not equal to the solar azimuth angle φ_{S}, the sunlight penetration distance d_{PEN} is a function of the cosine of the difference between the angle φ_{F} and the solar azimuth angle φ_{S}, i.e.,

d_{PEN}=l·cos(|φ_{F}−φ_{S}|), (Equation 2)

as shown by the top view of the window 166.

As mentioned above, the solar elevation angle θ_{S} and the solar azimuth angle θ_{S} define the position of the sun in the sky and are functions of the position (i.e., the longitude and latitude) of the building in which the space 160 is located and the present date and time. The following equations are necessary to approximate the solar elevation angle θ_{S} and the solar azimuth angle θ_{S}. The equation of time defines essentially the difference in a time as given by a sundial and a time as given by a clock. This difference is due to the obliquity of the Earth's axis of rotation. The equation of time can be approximated by

E=9.87·sin(2B)−7.53·cos(B)−1.5·sin(B), (Equation 3)

where B=[360°·(N_{DAY}−81)]/364, and N_{DAY} is the present day-number for the year (e.g., N_{DAY} equals one for January 1, N_{DAY} equals two for January 2, and so on).

The solar declination 6 is the angle of incidence of the rays of the sun on the equatorial plane of the Earth. If the eccentricity of Earth's orbit around the sun is ignored and the orbit is assumed to be circular, the solar declination is given by:

δ=23.45°·sin [360°/365·(N_{DAY}+284)]. (Equation 4)

The solar hour angle H is the angle between the meridian plane and the plane formed by the Earth's axis and current location of the sun, i.e.,

H(t)={¼·[t+E−(4·λ)+(60·t_{TZ})]}−180°, (Equation 5)

where t is the present local time of the day, λ is the local longitude, and t_{TZ} is the time zone difference (in unit of hours) between the local time t and Greenwich Mean Time (GMT). For example, the time zone difference t_{TZ} for the Eastern Standard Time (EST) zone is −5. The time zone difference t_{TZ} can be determined from the local longitude λ and latitude φ of the building 162. For a given solar hour angle H, the local time can be determined by solving Equation 5 for the time t, i.e.,

t=720+4·(H+λ)−(60·t_{TZ})−E. (Equation 6)

When the solar hour angle H equals zero, the sun is at the highest point in the sky, which is referred to as “solar noon” time t_{SN}, i.e.,

t_{SN}=720+(4·λ)−(60·t_{TZ})−E. (Equation 7)

A negative solar hour angle H indicates that the sun is east of the meridian plane (i.e., morning), while a positive solar hour angle H indicates that the sun is west of the meridian plane (i.e., afternoon or evening).

The solar elevation angle θ_{S} as a function of the present local time t can be calculated using the equation:

θ_{S}(t)=sin⁻¹[cos(H(t))·cos(δ)·cos(Φ)+sin(δ)·sin(Φ)], (Equation 8)

wherein Φ is the local latitude. The solar azimuth angle Φ_{S} as a function of the present local time t can be calculated using the equation:

Φ_{S}(t)=180°·C(t)·cos⁻¹[X(t)/cos(θ_{S}(t))], (Equation 9)

where

X(t)=[cos(H(t))·cos(δ)·sin(Φ)−sin(δ)·cos(Φ)], (Equation 10)

and C(t) equals negative one if the present local time t is less than or equal to the solar noon time t_{SN} or one if the present local time t is greater than the solar noon time t_{SN}. The solar azimuth angle φₛ can also be expressed in terms independent of the solar elevation angle θ_{S}, i.e.,

Φ_{S}(t)=tan⁻¹[−sin(H(t))·cos(δ)/Y(t)], (Equation 11)

where

Y(t)=[sin(δ)·cos(Φ)−cos(δ)·sin(Φ)·cos(H(t))]. (Equation 12)

Thus, the solar elevation angle θ_{S} and the solar azimuth angle φₛ are functions of the local longitude λ and latitude Φ and the present local time t and date (i.e., the present day-number N_{DAY}). Using Equations 1 and 2, the sunlight penetration distance can be expressed in terms of the height h_{WIN} of the window 166, the height h_{WORK} of the table 168, the solar elevation angle θ_{S}, and the solar azimuth angle Φ_{S}.

The lighting hubs 140 are operable to transmit digital messages to the motorized roller shades 104 to control the amount of sunlight entering a space 160 of a building 162 to control a sunlight penetration distance d_{PEN} in the space. Each lighting hub 140 comprises an astronomical timeclock and is able to determine a sunrise time t_{SUNRISE} and a sunset time t_{SUNSET} for each day of the year for a specific location. The lighting hubs 140 each transmit commands to the electronic drive units 130 to automatically control the motorized roller shades 104 in response to a timeclock schedule. Alternatively, the PC 150 could comprise the astronomical timeclock and could transmit the digital messages to the motorized roller shades 104 to control the sunlight penetration distance d_{PEN} in the space 160.

Additional details of a method for controlling shade position to control sun penetration distance are set forth in U.S. Pat. No. 8,288,981, which is incorporated by reference herein in its entirety.

The method of limiting depth of penetration as described with reference to FIGS. 9A to 9D is totally predictive, based on factors such as latitude, longitude, time of day, time of year, and direction which the façade containing the window 166 faces. In other words, the method of limiting depth penetration is based on a calculated position of the sun in relation to a given space 160, and is not based on external or internal sensor measurements. In urban areas, even when this algorithm shows no direct sun penetration, it is possible that unanticipated glare may result due to a reflection off of a structure. In such an instance, a point source of relatively high light intensity may be present, even though the above geographic and time factors do not predict that the sun is in a position to provide direct sunlight penetration, and even though the overall light intensity measured by the sensor is below the threshold for closing the shade completely.

Since glare is caused by a significant ratio of luminance between a subject (that which is being looked at) and a glare source, automated estimation of whether glare is present is complex, and can involve collection of plural measurements in different portions of the field of view.

As an approximation, in some embodiments, the system assumes that glare may be present whenever there is potential for direct sunlight penetration. In other embodiments, glare is assumed based on recent history (e.g., the previous 5 to 7 days) if the history of measured light intensity includes peaks that do not resemble the patterns associated with partly sunny days.

In other embodiments, without using a reflectance model of neighboring buildings, the system assumes that there is a reflective surface glare source if the sun is behind the building having the window treatment being controlled (without regard to whether such a reflective surface is present). That is, if the sunlight depth of penetration control algorithm described above determines that the sun is behind the building in which the window treatment is located, with a given solar elevation angle, then a determination is made whether the desired sun penetration depth would be exceeded for a smaller solar elevation (e.g., ½ of the actual solar elevation) if the sun were in front. This approach assumes the presence of an imaginary sun behind an assumed reflective surface, and determines if the imaginary sun would produce glare. This approach may prevent exposure of occupants to actual glare, but in some cases will close the window treatment when there is no glare.

Although many of the processes above are described as being performed by the controller of the EDU 130, any of the processes could be performed by any suitable controller in the system. For example, in a central control processor 150, lighting hub 140. In addition, any of the sensors 180, 113 may be a “smart sensor” unit, which includes a sensor, a microcontroller and memory in a package or enclosure. A smart sensor of this type is capable of performing some of the computations described above. In some embodiments, the processes are distributed and performed by two or more separate controllers.

The methods and system described herein may be at least partially embodied in the form of computer-implemented processes and apparatus for practicing those processes. The disclosed methods may also be at least partially embodied in the form of tangible, non-transient machine readable storage media encoded with computer program code. The media may include, for example, RAMs, ROMs, CD-ROMs, DVD-ROMs, BD-ROMs, hard disk drives, flash memories, or any other non-transient machine-readable storage medium, wherein, when the computer program code is loaded into and executed by a computer, the computer becomes an apparatus for practicing the method. The methods may also be at least partially embodied in the form of a computer into which computer program code is loaded and/or executed, such that, the computer becomes a special purpose computer for practicing the methods. When implemented on a general-purpose processor, the computer program code segments configure the processor to create specific logic circuits. The methods may alternatively be at least partially embodied in a digital signal processor formed of application specific integrated circuits for performing the methods.

Although the subject matter has been described in terms of exemplary embodiments, it is not limited thereto. Rather, the appended claims should be construed broadly, to include other variants and embodiments, which may be made by those skilled in the art.

What is claimed is:

1. A system comprising:
a window treatment positioned adjacent to a window or skylight of a room;
a motor associated with the window treatment, for varying a position of the window treatment;
a sensor for measuring an outdoor light level at the window or skylight;
a controller for generating and transmitting signals to the motor to automatically adjust the position of the window treatment so as to control a task illumination at a predetermined location in the room based on the measured outdoor light level at the window or skylight.

2. The system of claim 1, wherein the controller is configured to:
determine whether a predetermined minimum time interval has passed since a most recent movement of the window treatment; and
delay a movement of the window treatment for increasing an unshaded area of the window or skylight, if the predetermined minimum time interval has not passed.

3. The system of claim 1, wherein:
the controller has a non-transitory machine readable storage medium encoded with a plurality of preset positions for the window treatment, and data representing a plurality of coefficients of utilization, each predetermined coefficient of utilization corresponding to a respective one of the preset window treatment positions; and
the controller is configured for generating and transmitting signals to the motor to automatically adjust the position of the window treatment to the one of the preset positions corresponding to a nearest one of the predetermined coefficient of utilization that is less than or equal to the a calculated coefficient of utilization based on measured light level.

4. The system of claim 3, wherein the window has one or more architectural features, and at least one of the preset positions is selected to cause a bottom of the window treatment to align with one of the architectural features.

5. The system of claim 1, wherein the controller has a non-transitory machine readable storage medium encoded with a recent history of light levels measured by the sensor, and the controller is configured to:
determine an expected increase or decrease in the light level during a planning period based on the recent history of light levels; and
select the position of the window treatment corresponding to a maximum light level expected during the planning period.

6. The system of claim 1, wherein the controller is configured to select the position of the window treatment further taking into account a position of the sun.

7. The system of claim 1, wherein the controller is configured to automatically adjust the position of the window treatment taking into account a transmittance of the window or skylight, a material constituting the window treatment, and a coefficient of utilization of light.

8. The system of claim 7, wherein, depending on a lighting condition, the controller is configured to select a coefficient of utilization from one of the group consisting of a diffuse light coefficient of utilization and a direct sunlight coefficient of utilization.

9. The system of claim 1, wherein the controller is configured to:
determine respective window treatment positions based on task illumination and using at least one additional method from the group consisting of limiting depth of penetration of sunlight and limiting predicted glare, and
cause the window treatment to move to whichever one of the positions based on task illumination, limiting depth of penetration of sunlight and limiting predicted glare admits the least sunlight.

10. A method of controlling a motorized window treatment adjacent to a window or skylight, the method comprising:
(a) measuring a light intensity at the window having the window treatment adjacent thereto;
(b) computing a first position of the window treatment based on the measured light intensity, that is expected to produce a predetermined interior illuminance at a predetermined position in a room containing the window or skylight; and
(c) automatically actuating the window treatment to the first position.

11. The method of claim 10, further comprising:
computing a predicted maximum light intensity at the window during an interval following the measuring, based on the measured light intensity,
wherein the first position is determined by the predicted maximum light intensity.

12. The method of claim 10, further comprising:
computing a second position of the window treatment, corresponding to a predetermined maximum sunlight penetration distance of the room;
automatically actuating the window treatment to the second position, if in the second position the window treatment permits less light to pass than when the window treatment is in the first position.

13. The method of claim 10, wherein step (b) includes:
(b1) computing an effective transmittance of the window based on the predetermined illuminance and the measured light intensity, the effective transmittance corresponding to a first portion of the window covered by the window treatment and a second portion of the window not covered by the window treatment; and
(b2) computing the first position based on the computed effective transmittance.

14. The method of claim 13, wherein computing the effective transmittance is also based on a predetermined coefficient of utilization of a predetermined location within the room.

15. The method of claim 14, wherein the coefficient of utilization takes into account dimensions of the room and dimensions of the window.

16. The method of claim 13, wherein step (b2) takes into account a transmittance of a material of which the window treatment is comprised.

17. The method of claim 10, further comprising:
receiving an input designating an expected use of the room; and
automatically selecting the predetermined interior illuminance based on the expected use.

18. The method of claim 10, wherein step (a) is performed using an outdoor sensor, and the effective transmittance takes into account absorption and reflection of light by the window.

19. The method of claim 10, wherein step (a) is performed using a sensor between the window the window treatment, and the measuring in step (a) takes into account absorption and reflection of light by the window.

20. The method of claim 10, wherein step (a) is performed using a first sensor which is not responsive to illuminance within the room, further comprising:
measuring illuminance within the room using a second sensor; and
automatically controlling at least one light in the room based on an output of the second sensor, so as to achieve the predetermined interior illuminance.

21. The method of claim 10, further comprising using a PID controller to control one of the group consisting of velocity and position of the window treatment during the actuating step (c).

22. A method of controlling a motorized window treatment adjacent to a window, the window located on a wall of a room, the method comprising:
(a) measuring a light intensity at the window having the window treatment adjacent thereto;
(b) computing a predicted maximum light intensity at the window during an interval following the measuring, based on the measured light intensity;
(c) computing a first position of the window treatment based on the predicted maximum light intensity, such that exposing the window and window treatment to light having the predicted maximum light intensity would produce a predetermined interior illuminance; and
(d) computing a second position of the window treatment for use during the interval, corresponding to a predetermined maximum sunlight penetration distance of the room;
(e) automatically actuating the window treatment to whichever one of the first and second positions that permits less light past the window treatment.

23. A non-transitory machine readable storage medium encoded with computer program code, such that when the code is executed by a processor, the processor performs a method of controlling a motorized window treatment adjacent to a window or skylight, comprising:
(a) receiving a value of light intensity measured at the window or skylight having the window treatment adjacent thereto;
(b) computing a first position of the window treatment based on the measured light intensity, that is expected to produce a predetermined interior illuminance at a predetermined position in a room containing the window or skylight; and
(c) automatically causing the window treatment to move to the first position.

24. The non-transitory machine readable storage medium of claim 23, wherein the method further comprises:
computing a second position of the window treatment, corresponding to a predetermined maximum sunlight penetration distance of the room;
automatically causing the window treatment to move to the second position, if in the second position the window treatment permits less light to pass than when the window treatment is in the first position.

25. A method of controlling a motorized window treatment adjacent to a window or skylight, the method comprising:
(a) measuring a light intensity at the window having the window treatment adjacent thereto;
(b) computing a first position of the window treatment based on the measured light intensity;
(c) determining an interior illuminance at a predetermined position in a room containing the window or skylight based on the first position of the window treatment; and
(d) automatically actuating the window treatment to an additional window treatment position corresponding to the first position.
